(19) United States
(12) Patent Application Publication
(10) Pub. No.: US 2019/0293441 A1
(43) Pub. Date: Sep. 26, 2019

(54) METHOD OF ROUTE PLANNING AND HANDLING PROHIBITED COMPLEX DRIVING MANEUVERS

(71) Applicant: MITAC INTERNATIONAL CORP., Taoyuan City (TW)

(72) Inventors: Alexander Melnikov, San Dimas, CA (US); Viktor Kanaev, San Dimas, CA (US)

(21) Appl. No.: 15/935,050

(22) Filed: Mar. 25, 2018

(51) Int. Cl. G01C 21/34

(52) U.S. Cl. CPC G01C 21/3453

(57) ABSTRACT

A method of route planning and handling prohibited complex driving maneuvers is provided. An OPEN list and a CLOSED list of an A-Star algorithm are initiated. A first node from the OPEN list is selected as a processing node. One or multiple filtered complex maneuver restrictions of the first node are stored in a rule list before acquiring a second node connected to the processing node. The second node is added to the OPEN list when the second node is allowed to be selected according to the rule list.

### BACKGROUND OF THE INVENTION

### 1. Field of the Invention

The present invention is related to a route-planning method, and more particularly, to a route-planning method capable of handling prohibited complex driving maneuvers.

### 2. Description of the Prior Art

Today's navigation applications on mobile devices such as smart phones, desktop computers, or in-vehicle navigation systems assist users in devising optimum travel routes to destinations, help users understand vehicle orientation and direction of travel, illustrate various places of interest, and inform the driver about driving conditions on a road network.

When a vehicle moves along roads, streets and highways, the vehicle may encounter two kinds of restrictions on driving maneuverability: traffic restrictions that are always present (“non-lapsing vehicle restrictions” or NLVRs) and traffic restrictions that vary with the time of day, with the day of the week, or with the season (“timed vehicle restrictions” or TVRs). Examples of the timed vehicle restrictions include No-Left-Turn, No-Right-Turn and No-U-Turn restrictions that are imposed during commute or rush hours or for heavy vehicles, specially marked traffic lanes that can be used only by “carpool” vehicles (carrying two or three or more persons) during commute or rush hours, and side lanes that can be used for vehicle parking during portions of the day that are not commute or rush hours. Obviously, a navigation system without traffic restriction mechanism decreases the benefit of using the tool.

FIG. 1 is a navigation graph representing a street map for input of a prior art route-planning algorithm. A set of locations and the connections between them in the street map may be represented by “nodes” and “segments” in the navigation graph. Standard Dijkstra algorithm operates with the navigation graph as depicted in FIG. 1 and may be used to find the shortest path between any nodes among A˜F. However, it does not properly take turn restrictions into account, neither simple turn (consisting of only two segments) restrictions nor complex maneuver (consisting of more than 2 segments) restrictions. Assume the cost of getting from node F to node A is 3 unit, the cost of getting from node A to node B is also 3 unit, the cost of getting from node F to node G is 1 unit, the cost of getting from node G to node E is 1 unit, and the cost of getting from node E to node B is 10 unit. Thus, the path with minimum cost from node F to node C may be acquired as F->A->B->C with a cost of 6 units according to standard Dijkstra algorithm. However, the acquired path of F->A->B->C may encounter a forbidden left-turn restriction by going through the path A->B->C.

In order to fix above mentioned problem and find the allowed shortest path which takes simple turn restrictions into account, the associated node B is split into two nodes in the navigation graph. More specifically, since the left-turn restriction takes place on node B, based on node B, we assign segment E->B with an identification number ID=0, assign segment D->B with an identification number ID=1, assign segment A->B with an ID of 2, and assign segment C->B with an identification number ID=3. After that, each segment connecting node B is assigned with a turn restriction mask. Each bit in the turn restriction mask indicates whether a turn from a first segment to a second segment is allowed (set to 0) or forbidden (set to 1). For the forbidden left-turn restriction on A->B->C, segment A->B has a turn restriction mask [1000] which indicates that if one goes from node A to node B through segment A->B, it is forbidden to continue onto the segment with ID=3, which represents segment B->C (the left-most bit set to 1 corresponds to segment C->B having ID=3). On the contrary, segment E->B has a turn restriction mask [0000] which indicates that there is no forbidden turn restrictions after one goes from node E to node B, and thus one can then go to nodes A, C or D. Similarly, the turn restriction mask for segment D->B and segment C->B are also [0000].

FIG. 2 is a modified navigation graph representing a street map with simple turn restrictions for input of a prior art route-planning algorithm. The original node B is interpreted by a navigation engine as two separate nodes B1 and B2 with the information of the turn restriction mask mentioned above. This way, as the routing arrives at node B1 from A, the path cannot continue onto node C and thus the illegal left-turn A->B->C is excluded while other possibilities to reach node C from node F is preserved by another node B2. However, many turn restrictions in our daily driving maneuverability are not simple turn restrictions but complex maneuvers, so that above mentioned navigation system implemented with simple turn restriction masks is unable to handle complex maneuvers.

Another technique has been introduced to tackle complex maneuvers restriction called ghost arc. A ghost arc refers to an artificial segment of an original segment with geometry and all attributes (except unique identifier link ID) equal to the original segment. A next segment is the segment in the complex maneuver subsequent to the original segment. For a complex maneuver having n segments (n>2), a ghost arc is generated for each intermediate segments except for the first and the last segments. Each complex maneuver restriction is decomposed into multiple simple turn restrictions each represented by a corresponding ghost arc. By creating such road network with ghost arcs, each complex maneuver restriction may be implemented using traditional simple turn restrictions by setting the rules of multiple ghost arcs.

The above-mentioned ghost arc scheme for tackling complex maneuver restrictions requires huge amount of pre-defined rules. Different vehicle types, vehicle status or time of travel requires different rule sets, which complicates the route-finding process. Therefore, a prior art navigation system implemented with the above-mentioned simple turn restriction or ghost arc technique for tackling complex maneuver restrictions requires huge amount of computation which reduces efficiency and performance of the navigation system.

### SUMMARY OF THE INVENTION

The present invention provides a method of route planning and handling prohibited complex driving maneuvers. The method includes receiving an initial node of a route, a goal node of the route, and a designated parameter, initializing an OPEN list and a CLOSED list, adding the initial node of a route to the OPEN list, extracting a node with a lowest estimated cost according to the designated parameter from the OPEN list as a processing node, storing one or multiple successor nodes connected to the processing node as a successor group if the processing node is not the goal node, selecting one of the one or multiple successor nodes as a candidate node, generating one or multiple maneuver masks for the candidate node so as to form one or multiple virtual nodes which mark different parent segments related to one or multiple maneuver restriction of the candidate node if a parent segment from the processing node to the candidate node is involved in the one or multiple maneuver restriction, and moving the processing node from the OPEN list to the CLOSED list if the candidate node is an end node of the maneuver restriction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a navigation graph representing a street map for input of a prior art route-planning algorithm.

FIG. 2 is a modified navigation graph representing a street map with simple maneuver restrictions for input of a prior art route-planning algorithm.

FIG. 3 is a navigation graph representing a street map for input of a route-planning algorithm.

FIGS. 4A-4C show a flowchart illustrating a route-planning method capable of handling prohibited complex driving maneuvers according to an embodiment of the present invention.

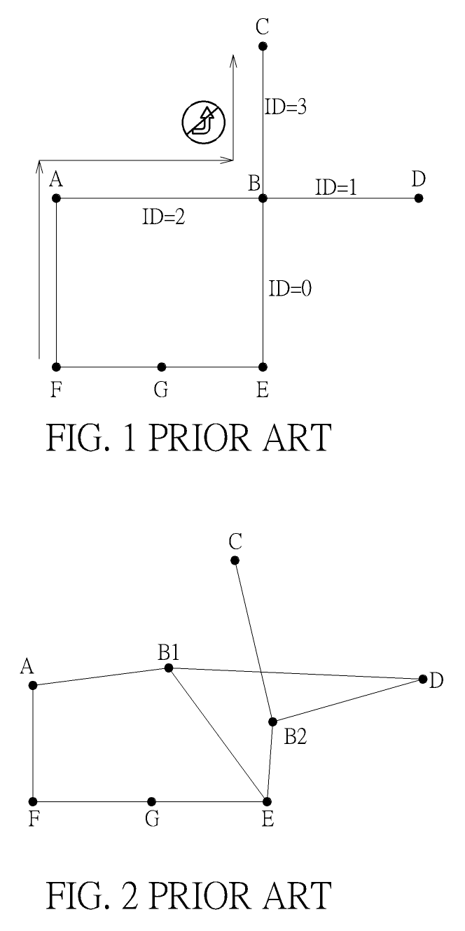

### DETAILED DESCRIPTION

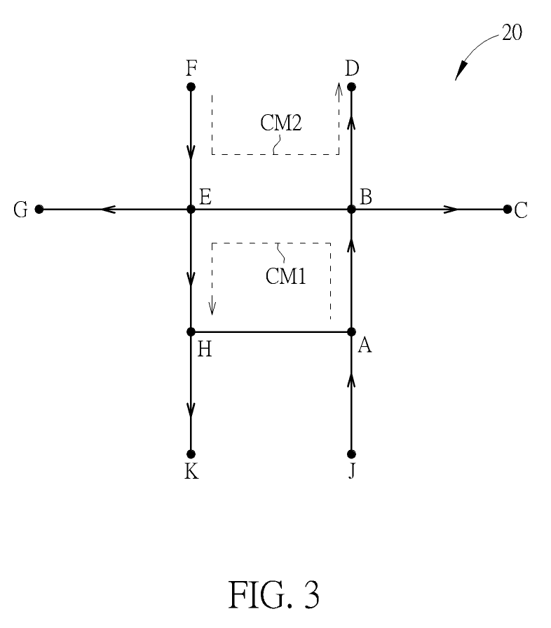

FIG. 3 is a navigation graph 20 representing a map architecture for a route-planning. The navigation graph 20 is a simulation of streets, crossroads and traffic rules in real world constructed by multiple virtual nodes and segments. Segment J̅A̅, segment A̅B̅ and segment B̅D̅ are integrally connected to represent one side of a street allowing driving in the direction from node J to node D. Similarly, segment F̅E̅, segment E̅H̅ and segment H̅K̅ are integrally connected to represent the other side of the street allowing the direction from node F to node K. Segment B̅C̅ and segment E̅G̅ are byways connected to the street. Segment B̅C̅ represents a one-way street which only allows driving in the direction from node B to node C, and segment E̅G̅ represents a one-way street which only allows driving in the direction from node E to node G. Segment B̅E̅ is a virtual segment showing a U-turn maneuver from one side of the street to another side of the street. However, U-turn through nodes A->B->E->H and F->E->B->D are both forbidden in the present case. Segment H̅A̅ is another virtual segment at different position showing a U-turn maneuver from one side of the street to another side of the street. But, different from segment B̅E̅, U-turn through nodes E->H->A->B is allowed while U-turn through nodes J->A->H->K is forbidden. The complex maneuvers CM1 and CM2 represent U-turns at node B and node E through A->B->E->H and F->E->B->D, respectively.

In the present invention, based on the traffic rules, each node in the navigation graph 20 contains several forbidden maneuvers, but it is not limited to simple forbidden turns. Forbidden left turn, for bidden right turn, U-turns and complex forbidden turn sequences are all considered as forbidden maneuvers. Still, some of the turn restrictions may change upon time or differ from the car types, thus the rules are dynamic. Therefore adjusting the route architecture beforehand would be really hard and inefficient. Consequently, to process route planning considering multiple kinds of forbidden maneuvers in runtime, the present invention generates virtual nodes by processing the nodes with corresponding complex maneuver masks and then filters out illegal nodes before putting nodes into an Open list while processing route planning work.

That is, if a node n corresponds to an intermediate node of a forbidden maneuver, two corresponding complex maneuver masks CMM(n) would be generated, wherein one complex maneuver mask CMM(n) indicates a situation that the current route is engaging to a forbidden maneuver at node n, and the other one indicates the current route isn't engaging any forbidden maneuver at node n. Similarly, if the node n corresponds to an intermediate node of more than one forbidden maneuvers, more corresponding complex maneuver masks CMM(n) would be generated. For example as indicated in FIG. 3, trucks are not allowed to make U-turns at node B and node E through complex maneuvers CM1 and CM2. Thus, for their intermediate node B or node E, each contains 3 complex maneuver masks CMM(n). On the other hand, since forbidden maneuvers are ruling the turn restrictions and a single turn involves two segments, it is clear that there would be at least one intermediate node within a forbidden maneuver.

In the present invention, as previous described previously, the forbidden maneuvers may be changed in different scenarios, thus it is necessary to select related forbidden maneuvers depending on the driving condition such as vehicle type/status and time of travel, so as to determine all applicable forbidden maneuvers for route-planning under a certain driving condition. Assuming that there are i forbidden maneuvers associated with the node n and that the node is not the endpoint of the i forbidden maneuvers, an i-bit complex maneuver mask may be stored for the node n, wherein each bit is used to reflect the status of each forbidden maneuver each designated by a unique arc ID. The bit associated with a forbidden maneuver in the complex maneuver mask of node n is raised (set to 1) only when the route planning goes to node n through the beginning arc of the forbidden maneuver, or is otherwise reset (set to 0).

More specifically for illustrative purpose, it is assumed that the forbidden maneuver A->B->E->H is assigned with an identification number ID=0 relative to node B, the maneuver F->E->B->D is assigned with an identification number ID=1 relative to node B, the maneuver A->B->E->H is assigned with an identification number ID=1 relative to node E, and the maneuver F->E->B->D is assigned with an identification number ID=0 relative to node E. Under such circumstance, the complex maneuver mask at node B is [01] if the incoming arc is A->B, wherein the first bit is 1 indicating the current route is involved in a forbidden maneuver A->B->E->H. The complex maneuver mask at node B is [10] if the incoming arc is F->E->B, wherein the second bit is 1 indicating the current route is involved in a forbidden maneuver F->E->B->D, and [00] for all other incoming arcs which are not involved in any forbidden maneuver. Therefore, node B may be split into three nodes, interpreted by the navigational engines as node B1 (node B with complex maneuver mask [01]), node B2 (node B with complex mask [10]), and node B3 (node B with complex mask [00]).

Similarly, the complex maneuver mask at node E is [01] if the incoming arc is F->E, wherein the first bit is 1 indicating the current route is involved in a forbidden maneuver F->E->B->D. The complex maneuver mask at node E is [10] if the incoming arc is A->B->E, wherein the second bit is 1 indicating the current route is involved in a forbidden maneuver F->E->B->D, and [00] for all other incoming arcs which are not involved in any forbidden maneuver. Therefore, node E may be split into three nodes, interpreted by the navigational engines as node E1 (node E with complex mask [01]), node E2 (node E with complex mask [10]), and node E3 (node E with complex mask [00]). This way, as the routing arrives at node B from the arc F->E->B, the path cannot continue to node D and form the illegal U-turn F->E->B->D; as the routing arrives at node E from the arc A->B->E, the path cannot continue to node H and form the illegal U-turn A->B->E->H.

As well-known to those skilled in the art, Dijkstra's algorithm, or other route finding algorithms would put nodes into the CLOSED list after those nodes are calculated or considered, so that each node won't be redundantly calculated again. However, Since present route-planning method introduces a process to filter out illegal nodes performing forbidden maneuvers at an early stage when processing putting which nodes into the OPEN list, and to create virtual nodes in runtime for the intermediate nodes participated in any forbidden restriction so as to preserve possible routes going to those intermediate nodes through other legal routes because there are more than one node that could be put into the CLOSED list. Therefore, the present method may be simply integrated with those common route finding algorithm and solve the route planning tasks considering complex forbidden restrictions in runtime.

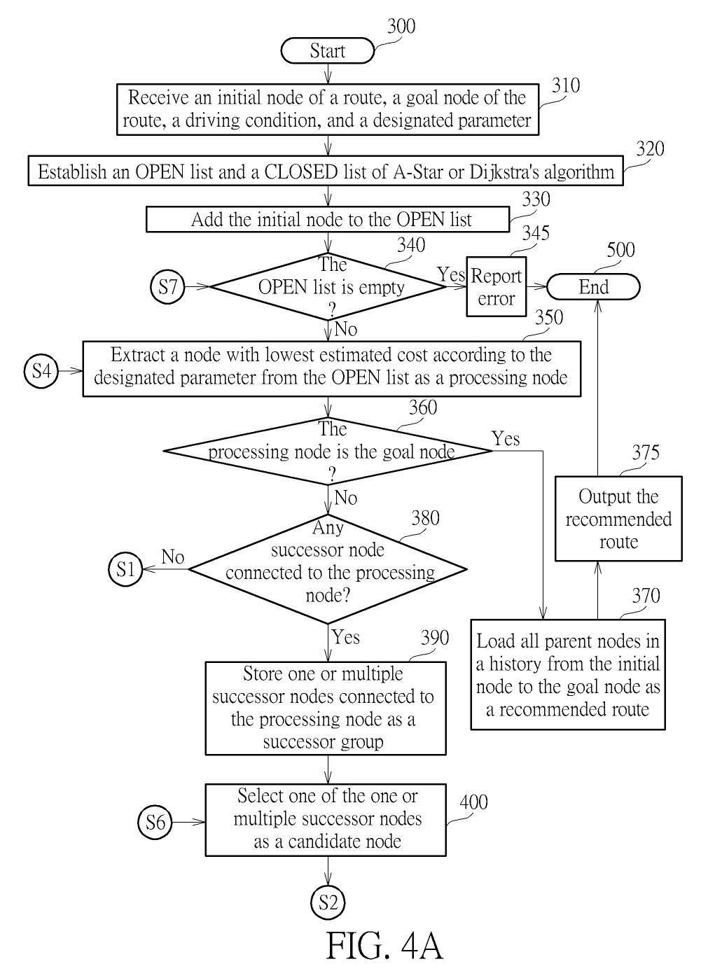

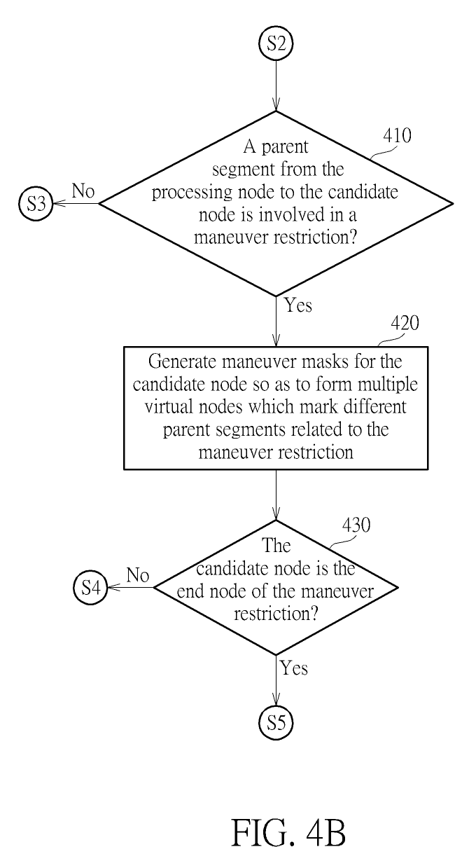

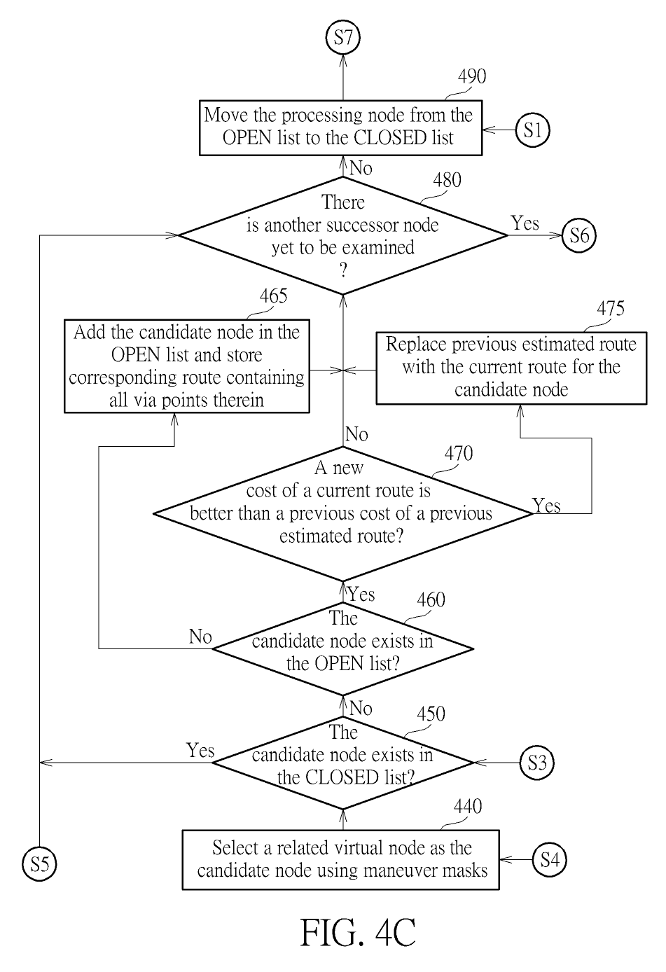

FIGS. 4A-4C show a flowchart illustrating a route-planning method capable of handling prohibited complex driving maneuvers according to an embodiment of the present invention.

Step 300: start; execute step 310.

Step 310: receive an initial node of a route, a goal node of the route, a driving condition, and a designated parameter; execute step 320.

Step 320: establish an OPEN list and a CLOSED list of A-Star or Dijkstra's algorithm; execute step 330.

Step 330: add the initial node to the OPEN list; execute step 340.

Step 340: determine if the OPEN list is empty; if yes, execute step 345; if no, execute step 350.

Step 345: report error; execute step 600.

Step 350: extract a node with a lowest estimated cost according to the designated parameter from the OPEN list as a processing node; execute step 360.

Step 360: determine if the processing node is the goal node; if yes, execute step 370; if no, execute step 380.

Step 370: load all parent nodes in a history from the initial node to the goal node as a recommended route; execute step 600.

Step 375: output the recommended route; execute step 600.

Step 380: determine if there is any successor node connected to the processing node; if yes, execute step 390; if no, execute step 490.

Step 390: store one or multiple successor nodes connected to the processing node as a successor group; execute step 400.

Step 400: select one of the one or multiple successor nodes as a candidate node; execute step 410.

Step 410: determine if a parent segment from the processing node to the candidate node is involved in a maneuver restriction; if yes, execute step 420; if no, execute step 450.

Step 420: generate maneuver masks for the candidate node so as to form multiple virtual nodes which mark different parent segments related to the maneuver restriction; execute step 430.

Step 430: determine if the candidate node is the end node of the maneuver restriction; if yes, execute step 480; if no, execute step 440.

Step 440: select a related virtual node as the candidate node using maneuver masks; execute step 450.

Step 450: determine if the candidate node exists in the CLOSED list; if yes, execute step 480; if no, execute step 460.

Step 460: determine if the candidate node exists in the OPEN list; if yes, execute step 470; if no, execute step 465.

Step 465: add the candidate node in the OPEN list and store corresponding route containing all via points therein; execute step 480.

Step 470: determine if a new cost of a current route is better than a previous cost of a previous estimated route, wherein the new cost and the previous cost are estimated from the initial node to the candidate node through corresponding routes; if yes, execute step 475; if no, execute step 480.

Step 475: replace previous estimated route with the current route for the candidate node; execute step 480.

Step 480: determine if there is another successor node yet to be examined; if yes, execute step 400; if no, execute step 490.

Step 490: move the processing node from the OPEN list to the CLOSED list; execute step 340.

Step 500: End.

In step 310, an initial node of a route, a goal node of the route, a driving condition, and a designated parameter may be provided. The driving condition is associated with vehicle type, vehicle status (number of passengers) and time of travel. The designated parameter is associated with the cost of getting from a first node to a second node, and may further be associated with the estimate of the cost of getting from the first to the second node according to the heuristic function. For illustrative purpose, it is assumed that node A in FIG. 2 is the initial node of the present route-planning process and there is no prohibited maneuver on the segment A-B.

In step 320, an OPEN list and a CLOSED list of A-Star or Dijkstra's algorithm is established, which is not limited thereto. The OPEN list keeps track of those nodes that need to be examined, while the CLOSED list keeps track of nodes that have already been examined.

In step 330, the OPEN list contains just the initial node 330, and the CLOSED list is empty. If somehow no node exists or remains in the OPEN list in step 340, step 345 may be executed for reporting error.

In step 350, the node with the lowest estimated cost according to the designated parameter from the OPEN list as the processing node. In the embodiment when Dijkstra's algorithm is used in step 320, the extracted node with the lowest estimated cost provides a shortest path from the initial node. In the embodiment when A-star algorithm is used in step 320, the estimate of the cost of getting from the initial to the current node and an anticipated cost from current node to goal node according to a heuristic function are taken into consideration when calculating the cost of the nodes in the OPEN list.

If it is determined in step 360 that the processing node is the goal node, it means that the present route planning method has arrived at the destination. Step 370 is then executed for providing the recommended route by loading all parent nodes in a history from the initial node to the goal node. The recommended route may then be outputted in step 375.

If it is determined in step 360 that the processing node is not the goal node and it is determined in step 380 that there is one or multiple successor nodes connected to the processing node, the one or multiple successor nodes are stored as a successor group in step 390.

After selecting one of the one or multiple successor nodes as the candidate node in step 400, step 410 is executed for determining if the parent segment from the processing node to the candidate node is involved in a maneuver restriction. In an embodiment of the present invention, maneuver restrictions of each node of concern may be loaded and filtered based on the driving condition (vehicle type/status or time of travel). The filtered maneuver restrictions may then be stored in a rule list. More specifically, when planning for the same route, the filtered maneuver restrictions stored in the rule list of the same node for day-time travel may be different from that for night-time travel. In the present embodiment, the maneuver restrictions are turn restrictions, such as forbidden right turn, forbidden left turn, or forbidden U-turn.

In step 420, maneuver masks are generated for the candidate node so as to form multiple virtual nodes which mark different parent segments related to the maneuver restriction. If the candidate node is an intermediate node of a specific maneuver restriction, a bit is required for the maneuver masks to represent different incoming situations. Thus, if the candidate node corresponds to be the intermediate nodes of i maneuver restrictions, the maneuver mask of the candidate node includes i bits wherein each bit represents whether the route history performs a corresponding maneuver restriction. In other words, if one or multiple parent nodes of the candidate node match the start point and every intermediate nodes of the specific maneuver restriction till the candidate node, the bit associated with the specific maneuver restriction should be set to 1. Otherwise, the bit associated with the specific maneuver restriction is set to 0. More specifically, as shown in FIG. 3, suppose there are two forbidden maneuvers through nodes sequence F->E->B->D and A->B->E->H. When a route plans to go from node J through node A, node B till node E, then there is one corresponding bit set to 1 in the maneuver masks of node E indicating the current route plan is encountering a forbidden maneuver A->B->E->H. Similarly, if there is another forbidden maneuver through node sequence B->E->H, there is also another corresponding bit set to 1 in the maneuver masks of node E. In a preferred embodiment, when there are i maneuver restrictions related to the candidate node, then i+1 virtual nodes are generated so that the candidate node could be considered more than one time since there is more than one nodes could be put into the Open list, and the possibilities to test other routes through this candidate node could be preserved for the route finding algorithm. Therefore, generating virtual nodes when there is at least one maneuver restriction can prevent the route planning from eliminating potential possibilities in finding routes

More specifically, it is assumed that an U-turn driving maneuver F->E->B->D (CM2), an U-turn driving maneuver A->B->E->H (CM1), a left turn driving maneuver A->B->E (SM1) are all set to be forbidden maneuvers at node B. If the node B has a history of coming through node F and then node E, sequentially, the bit associated with the forbidden maneuver “F->E->B->D” stored in the complex maneuver mask of node B is set to 1.

If it is determined in step 430 that the candidate node is not the end node of the maneuver restriction, a related virtual node is selected as the candidate node using the maneuver masks in step 440 for subsequent evaluations in steps 450-470.

If it is determined in step 450 that the candidate node already exists in the CLOSED list, step 480 is executed for evaluating other successor node yet to be examined. If it is determined in step 450 that the candidate node does not exist in the CLOSED list, step 460 is then executed for determining if the candidate node already exists in the OPEN list.

If it is determined in step 460 that the candidate node does not exist in the OPEN list, step 465 is executed for adding the candidate node in the OPEN list and storing corresponding route containing all via points therein, wherein the corresponding route starts from initial node to the candidate node. If it is determined in step 460 that the candidate node already exists in the OPEN list, step 470 is then executed for determining if the new cost of the current route is better than the previous cost of the previous estimated route, wherein the new cost and the previous cost are estimated from the initial node to the candidate node through corresponding routes.

If it is determined in step 450 that the candidate node does not exist in the CLOSED list and it is determined in step 460 that the candidate node already exists in the OPEN list, step 470 is then executed if the new cost of the current route is better than the previous cost of the previous estimate route, wherein the new cost and the previous cost are estimated from the initial node to the candidate node through corresponding routes. Step 475 is executed only when the new cost of the current route is better than the previous cost of the previous estimate route, which means the current route is a better option than the previous estimated route for getting to the candidate node from the initial node.

If it is determined in step 480 that there is no unexamined successor node, step 490 is then executed for moving the processing node from the OPEN list to the CLOSED list. After that, the present method loops back to step 340 and possibly to step 350 for evaluating other unexamined node in the OPEN set (if any).

One example is provided for explaining the present invention in more details. In order to find the shortest allowable route between a starting point of node F and the finish point of node C, the present route-planning method proceeds as the following stages:

One example is provided for explaining the present invention in more details. In order to find the shortest allowed route between a starting point of node F and the finish point of node D, the present route-planning method proceeds as the following stages:
(1) Put the initial node F into the OPEN list (step 330). The OPEN list now contains node F.
(2) Extract node F from the OPEN list (step 350). Node F has a single connecting node E, which has not been explored yet (not in the CLOSED set). Since segment F->E is beginning of the complex maneuver F->E->B->D with ID=1, node E with a mask [01] (hereafter referred as node E1) is put into the OPEN list (steps 410, 420, 430, 440, 450, 460 to 465), while node F is moved from the OPEN list to the CLOSED list (step 490). The OPEN list now contains node E1.
(3) Extract node E1 from the OPEN list (step 350). Node E1 has three connecting nodes B, G and H, which have not been explored yet (not in the CLOSED set). Since segments E->G and E->H are not present in any complex maneuvers, nodes G and H are added to the OPEN list (steps 410, 450, 460 to 465). Since the segment F->E->B is the beginning of the forbidden complex maneuver CM4 F->E->B->D with ID=10 relative to node B, node B with a mask [10] (hereafter referred as node B2) is put into the OPEN list (steps 410, 420, 430, 440, 450, 460 to 465), while node E1 is moved from the OPEN list to the CLOSED list (step 490). Now the OPEN list contains nodes B2, G and H.
(4) Extract node G from the OPEN list (step 350). Since node G does not have any connecting node, it is moved from the OPEN list to the CLOSED list (steps 380 to 490). The OPEN list now contains nodes H and B2.
(5) Extract node H from the OPEN list (step 350). Node H has two connecting nodes A and K, which have not been explored yet (not in the CLOSED set). Since segments H->K and H->A are not present in any complex maneuvers, nodes A and K are added to the OPEN list (steps 410, 450, 460 to 465), while node H is moved from the OPEN list to the CLOSED list (step 490). Now the OPEN list contains nodes A, B2 and K.
(6) Extract node B2 from the OPEN list (step 350). Node B2 has 3 connecting nodes C, D and E, which have not been explored yet (not in the CLOSED set). Since the routing F->E->B->D forms the forbidden complex maneuver CM4, node D is not put into the OPEN list (steps 410, 420, 430, 480 to 490). Since the routing F->E->B->C is not the start of any forbidden complex maneuver, node C is added to the OPEN list (steps 410, 450, 460 to 465). Since the routing F->E->B->E is the start of a forbidden complex maneuver, node E with a mask [00] (hereafter referred as node E3) is added to the OPEN list (steps 410, 420, 430, 440, 450, 460 to 465). Now the OPEN list contains nodes A, C, E3 and K.
(7) Extract node K from the OPEN list (step 350). Since node K does not have any connecting node, it is moved to the CLOSED list (steps 380 to 490). The OPEN list now contains nodes A, C and E3.
(8) Extract node A from the OPEN list (step 350). Node A has two connecting nodes B and J, which have not been explored yet (not in the CLOSED set). Since segment A->B is beginning of the forbidden complex maneuver CM3 of A->B->E->H with ID=01), node B with a mask [01] (hereafter referred as node B1) is added to the OPEN list (steps 410, 420, 430, 440, 450, 460 to 465). Since segments A->J is not present in any complex maneuvers, node J is added to the OPEN list (steps 410, 450, 460 to 465), and node A is moved to CLOSED set (step 490). Now the OPEN list contains nodes B1, B2, C, E3 and J.
(9) Extract node E3 from the OPEN list (step 350). Since node E3 has four connecting nodes B2, F, G and H which all have been previously explored (nodes that are already stored in the CLOSED list), no node is added to the OPEN list in this step (steps 380 to 490). Now the OPEN list contains nodes C, B1 and J.
(10) Extract node C (step 350). Since node C does not have any connecting node, it's not added to the OPEN list (step 380 to 490). The OPEN list now contains node B1 and J.
(11) Extract node B1 from the OPEN list (step 350). Node B1 has two connecting nodes D and E, which have not been explored yet (not in the CLOSED set). Since the routing A->B->E is beginning of the forbidden complex maneuver CM3 of A->B->E->II with ID=01 relative to node E, node E with a mask [10] (hereafter referred as node E2) is added to the OPEN list (steps 410, 420, 430, 440, 450, 460 to 465). Since A->B->D is not part of any forbidden complex maneuver, node D is put into the OPEN list as it is (steps 410, 450, 460 to 465), while node B1 is moved to CLOSED list (step 490). Now the OPEN list contains nodes D, E2 and J.
(12) Extract node E2 from the OPEN list (step 350). Node E2 has three connecting nodes F, G and H, which have not been explored yet (not in the CLOSED set). Since the routing A->B->E->H forms the forbidden complex maneuver CM3, node H is not added to the OPEN list (steps 410, 420, 430, 480 to 490). Although segment E->G is not part of any forbidden complex maneuver, nodes F and G have been previously explored with better cost, so node G is not added to the OPEN list (steps 410,450, 460, 470, 480 to 490). Now the OPEN list contains node D and J.
(13) Extract node D from the OPEN list (step 350). Since node D is the finish point, the shortest allowable path F->E->H->A->B->D has been acquired (step 360, 370, 375 to 500). Note that although the routing F->E->B->D is shorter than F->E->H->A->B->D, it violates the forbidden complex maneuver CM2 and thus will not be selected by the present route-planning method.

Most existing route-finding algorithms include two procedures. The first one is to put all neighboring nodes which do not exist in the CLOSE list into the OPEN list. The second one is to remove all examined nodes from the OPEN list and put them into the CLOSED list so as to avoid redundant calculation. Using the same example of explaining the present route-planning method as mentioned above, when a prior art route-finding algorithm is used to find the shortest allowed route between a starting point of node F and the finish point of node D, the routing F->E->B->D may be acquired. However, after determining that the routing F->E->B->D violates the forbidden complex maneuver CM4, the prior art route-finding algorithm may put the examined node E and node B into the CLOSED list, therefore unable to acquire the feasible of route of F->E->H->A->B->D. In the present route-planning method as mentioned above, multiple virtual nodes which mark different parent segments related to the maneuver restrictions of the candidate node are generated using corresponding maneuver masks before putting the candidate node in the OPEN list. Therefore, these virtual nodes may be considered multiple times as the routing expands, thereby preventing potential feasible routes to be eliminated.

In the present route-planning method, the complex maneuver mask CMM(n) is introduced in conjunction with the Dijkstra's algorithm or A-Star algorithm for filtering out any prohibited complex driving maneuvers. The complex maneuver mask CMM(n) is stored for each node n and may be used to create virtual nodes on runtime as the routing expands. Since the present method only needs to raise or reset the bits in the complex maneuver mask CMM(n), it does not require mass work on creating additional information or artificial rules in advance. Therefore, the present invention provides a route planning method capable of handling prohibited complex driving maneuvers efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of route planning and handling prohibited complex driving maneuvers comprising:
receiving an initial node of a route, a goal node of the route, and a designated parameter;
initializing an OPEN list and a CLOSED list;
adding the initial node of a route to the OPEN list;
extracting a node with a lowest estimated cost according to the designated parameter from the OPEN list as a processing node;
storing one or multiple successor nodes connected to the processing node as a successor group if the processing node is not the goal node;
selecting one of the one or multiple successor nodes as a candidate node;
generating one or multiple maneuver masks for the candidate node so as to form one or multiple virtual nodes which mark different parent segments related to one or multiple maneuver restriction of the candidate node if a parent segment from the processing node to the candidate node is involved in the one or multiple maneuver restriction; and
moving the processing node from the OPEN list to the CLOSED list if the candidate node is an end node of the maneuver restriction.

2. The method of claim 1, further comprising:
loading all parent nodes in a history from the initial node to the goal node as a recommended route if the processing node is the goal node.

3. The method of claim 1, further comprising:
selecting a related virtual node as a current candidate node using a corresponding maneuver mask if the candidate node is not the end node of the one or multiple maneuver restriction;
if the virtual node has not existed in the OPEN list or the CLOSE list, adding the related virtual node in the OPEN list and storing corresponding route containing all via points therein;
if the virtual node has not existed in the CLOSE list but exists in the OPEN list, replacing a previous estimated route with a current route for the candidate node if a new cost of a current route is better than a previous cost of a previous estimated route, wherein the new cost and the previous cost are estimated from the initial node to the current candidate node through corresponding routes;
moving the processing node from the OPEN list to the CLOSED list when all of the one or multiple successor nodes connected to the processing node have been examined.

4. The method of claim 1, further comprising:
if the virtual node has existed in the CLOSE list, moving the processing node from the OPEN list to the CLOSED list when all of the one or multiple successor nodes connected to the processing node have been examined.

5. The method of claim 1, wherein the designated parameter is associated with a cost of getting from a first node to a second node or an estimate of the cost of getting from the first node to the second node according to a heuristic function.

6. The method of claim 1, further comprising:
loading and filtering the one or multiple maneuver restrictions of the candidate node based on a driving condition which is associated with a vehicle type, a vehicle status or time of travel; and
storing the filtered one or multiple maneuver restrictions in a rule list.

7. The method of claim 1, further comprising:
setting a bit associated with a specific maneuver restriction among the one or multiple maneuver restriction to a first value if one or multiple parent nodes of the candidate node match a start point and every intermediate nodes of the specific maneuver restriction till the candidate node; or
setting the bit associated with the specific maneuver restriction among the one or multiple maneuver restriction to a second value different from the first value if the one or multiple parent nodes of the candidate node do not match the start point and every intermediate nodes of the specific maneuver restriction till the candidate node.

8. The method of claim 1 wherein:
there are i maneuver restrictions related to the candidate node;
(i+1) virtual nodes are generated; and
i is a positive integer.

9. The method of claim 1 further comprising:
abstracting a geographical region into a navigation graph which contains a plurality of nodes;
storing one or multiple complex maneuver restrictions in a complex maneuver mask for each node in the navigation graph, wherein each complex maneuver mask contains one or multiple bits each associated with a corresponding complex maneuver restriction; and
updating a value of each bit in each complex maneuver mask as a routing expands.

10. The method of claim 9 wherein:
the OPEN list is provided to keep track of the plurality of nodes in the navigation graph that need to be examined; and
the CLOSED list is provided to keep track of the plurality of nodes in the navigation graph that have already been examined.
